(19) United States
(12) Patent Application Publication
(10) Pub. No.: US 2024/0354885 A1
(43) Pub. Date: Oct. 24, 2024

(54) NON-TRANSITORY COMPUTER-READABLE MEDIUM AND SYSTEM FOR CONTENT MODIFICATION DETERMINATION

(71) Applicant: Square Enix Co. Ltd., Tokyo (JP)

(72) Inventor: Shinpei SAKATA, Tokyo (JP)

(21) Appl. No.: 18/641,069

(22) Filed: Apr. 19, 2024

(30) Foreign Application Priority Data
Apr. 21, 2023 (JP) 2023-070439

(51) Int. Cl. G06T 1/00

(52) U.S. Cl. CPC G06T 1/0028

(57) ABSTRACT

One or more embodiments of the disclosure provide a non-transitory computer readable medium comprising a program that, when executed, causes a server to perform: displaying automatically generated content; converting at least a portion of the automatically generated content into information (hereinafter, this is referred to as “determination information”) used to determine whether the content has been modified; generating a determination image from the determination information; and displaying the determination image together with the content.

### CROSS-REFERENCE TO RELATED APPLICATION(S)

The present application claims priority to and the benefit of Japanese Patent Application No. 2023-070439 filed on Apr. 21, 2023, the disclosure of which is expressly incorporated herein by reference in its entirety for any purpose.

### BACKGROUND

Conventionally, various systems have been proposed in which a digital watermark is added to a content in advance and used for authentication and management of the content.

In such a system, for example, a pattern that is the same as or similar to a digital watermark superimposed on an image is superimposed on a peripheral region of the digital watermark such that the apparent density becomes thinner as the distance from the digital watermark increases. Examples of such systems may be found in Japanese Patent Application Publication No. 2018-182509 A.

### SUMMARY

However, the conventional system generally adds predetermined information (e.g., a specific ID or information indicating a copyright holder) to various contents (e.g., an image) to be watermarked, and may not be able to determine whether or not the target image has been modified. That is, for example, in a case where a watermark indicating a specific ID is embedded in an image including text generated by a system that automatically generates text, even when a modification is made to replace a text portion in the image with another text, it may not be possible to determine from the watermark that the modification has been made. Therefore, there is a case where a burden for the provider of the content against the modification of the content by another person becomes excessive.

It is an object of at least one embodiment of the present invention to reduce a burden for responding to modification of content.

### Means for Solving the Problem

According to a non-limiting aspect, a program according to an embodiment of the present invention is a program for causing a server to realize a function of displaying automatically generated content, including: a converting function of converting at least a part of the automatically generated content into information (Hereinafter, this is referred to as “determination information”.) used to determine whether the content has been modified; and a generation function of generating a determination image from the determination information, this is for realizing a displaying function of displaying the determination image together with the content.

According to a non-limiting aspect, a system according to an embodiment of the present invention includes a communication network, a server, and a user terminal, and causes the server to realize a function of displaying automatically generated content, the system including: converting means for converting at least a part of the automatically generated content into information (Hereinafter, this is referred to as “determination information”.) used to determine whether the content has been modified; and generation means for generating a determination image from the determination information,

The image processing apparatus may further include a displaying unit configured to display the determination image together with the content.

According to a non-limiting aspect, a program according to an embodiment of the present invention is a program for causing a user terminal to realize a function of displaying automatically generated content, the program causing the user terminal to perform a converting function of converting at least a part of the automatically generated content into information (Hereinafter, this is referred to as “determination information”.) used to determine whether the content has been modified, and a generation function of generating a determination image from the determination information, this is for realizing a displaying function of displaying the determination image together with the content.

According to each embodiment of the disclosure, one or two or more problems are solved.

### BRIEF DESCRIPTION OF THE DRAWINGS

FIG. 1 is a block diagram showing an example of the configuration of a system corresponding to at least one of the embodiments of the present invention.

FIG. 2 is a block diagram showing a configuration of a server corresponding to at least one of the embodiments of the present invention.

FIG. 3 is a flowchart showing an example of information processing corresponding to at least one of the embodiments of the present invention.

FIG. 4 is a flowchart showing an example of the operation on the server side in the information processing corresponding to at least one of the embodiments of the present invention.

FIG. 5 is a flowchart showing an example of the operation on the terminal side in the information processing corresponding to at least one of the embodiments of the present invention.

FIG. 6 is a block diagram showing a configuration of a server corresponding to at least one of the embodiments of the present invention.

FIG. 7 is a flowchart showing an example of information processing corresponding to at least one of the embodiments of the present invention.

FIG. 8 is an explanatory diagram for explaining an example of a game screen corresponding to at least one of the embodiments of the present invention.

### DETAILED DESCRIPTION

Hereinafter, an example of an embodiment of the present invention will be described with reference to the drawings. Various constituent elements in the examples of the embodiments described below can be appropriately combined within a range in which no contradiction or the like occurs. Further, description of the content described as an example of a certain embodiment may be omitted in other embodiments. Further, the contents of operations and processes not related to the characteristic portions of the embodiments may be omitted. Further, the order of various processes constituting various flows described below is not the same as long as no contradiction occurs in the contents of the processes.

### First Embodiment

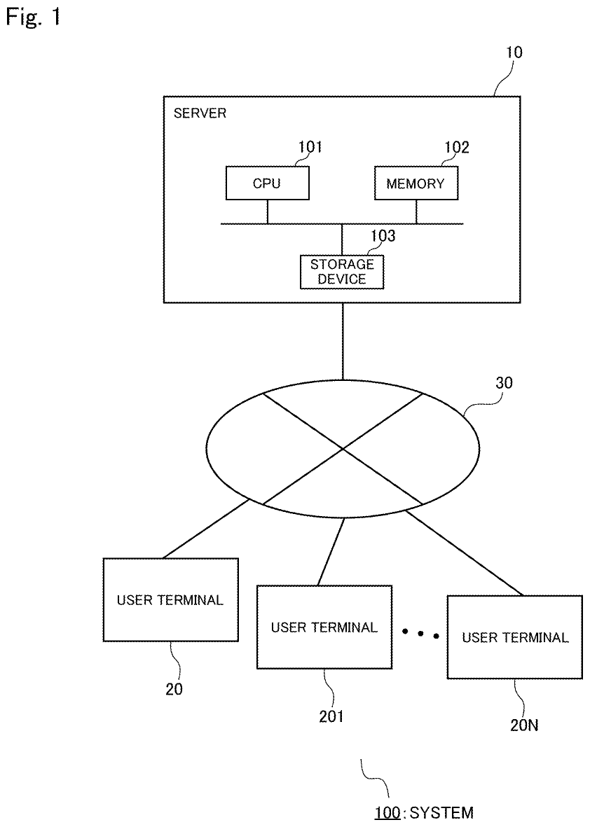

FIG. 1 is a block diagram illustrating an example of a configuration of a system 100 corresponding to at least one of the embodiments of the present invention. As illustrated in FIG. 1, the system 100 includes a server 10 and user terminals 20 and 201 to 20N (N is an arbitrary integer) used by users of the system 100. Note that the configuration of the system 100 is not limited to this, and a configuration may be adopted in which a single user terminal is used by a plurality of users, or a configuration may be adopted in which a plurality of servers are provided.

The server 10 and the plurality of user terminals 20 and 201 to 20N are connected to a communication network 30 such as the Internet. Although not shown, the plurality of user terminals 20 and 201 to 20N are connected to the communication network 30 by performing data communication with a base station managed by a communication provider via a wireless communication line.

The system 100 includes a server 10 and a plurality of user terminals 20 and 201 to 20N to realize various functions for executing various processes.

The server 10 is managed by an administrator of the system 100, and has various functions for providing information related to various processes to the plurality of user terminals 20 and 201 to 20N. In the present example, the server 10 is configured by an information processing apparatus such as a WWW server, and includes a storage medium that stores various kinds of information. The configuration of the server 10 is not particularly limited as long as it includes a general configuration for performing various processes as a computer, such as a control unit and a communication unit. Hereinafter, an example of a hardware configuration of the server 10 will be briefly described.

As illustrated in FIG. 1, the server 10 includes at least CPU (Central Processing Unit)101, a memory 102, and a storage device 103.

The CPU 101 is a central processing unit that performs various calculations and controls. When the server 10 includes a GPU (Graphics Processing Unit), a part of various calculations and controls may be performed by the GPU. The server 10 causes the CPU 101 to execute various types of information processing necessary for voice generation using data read out to the memory 102 as appropriate, and stores the obtained processing results in the storage device 103 as necessary.

The storage device 103 has a function as a storage medium for storing various kinds of information. The configuration of the storage device 103 is not particularly limited, but from the viewpoint of reducing the processing load on each of the plurality of user terminals 20 and 201 to 20N, it is preferable to have a configuration capable of storing all the various kinds of information necessary for voice generation. Such examples include HDDs and SSDs. However, the storage unit that stores various kinds of information may include a storage area in a state accessible by the server 10, and may have, for example, a dedicated storage area outside the server 10.

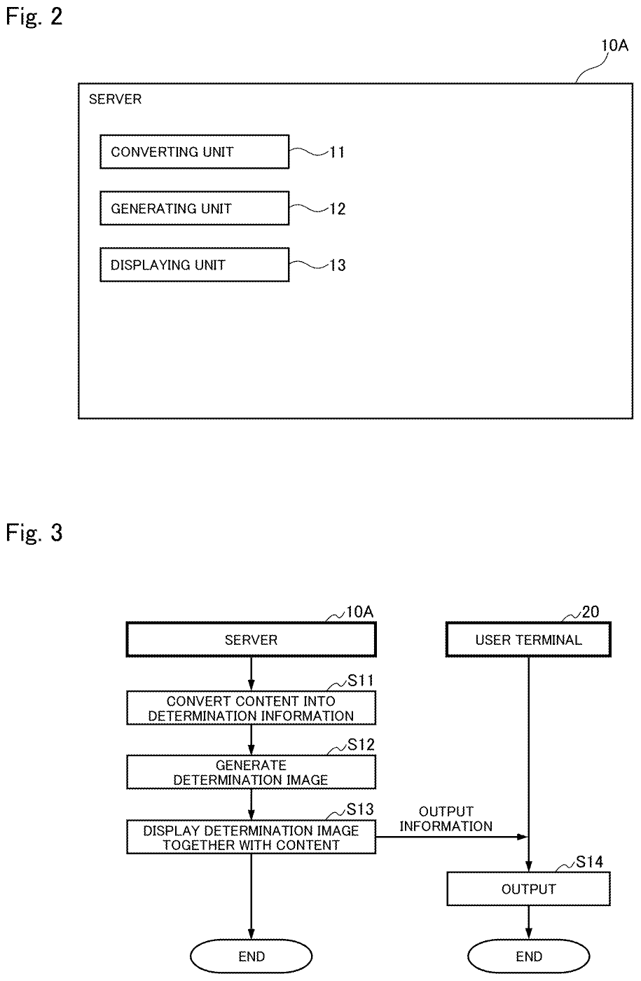

FIG. 2 is a block diagram showing a configuration of a server 10A which is an example of the server 10 corresponding to at least one of the embodiments of the present invention. As illustrated in FIG. 2, the server 10A includes at least a converting unit 11, a generating unit 12, and a displaying unit 13.

The converting unit 11 has a function of converting at least a portion of the automatically generated content into information used to determine whether the content has been modified (hereinafter referred to as “determination information”).

Here, the automatically generated content is not particularly limited as long as it is a content generated by artificial intelligence (AI), but is preferably a content generated by receiving an input of information by a user. Examples of the automatically generated content include various kinds of information such as character strings, images (still images and moving images), and sounds.

In addition, the determination information is not particularly limited as long as it is information used for determining whether or not the content has been modified, but it is preferable that the determination information be information that cannot be easily specified by the user who views the content. Examples of the determination information include information obtained by hashing a sentence as a content (irreversible information) and information obtained by encrypting an image as a content (reversible information). Since hashing and encryption are realized by a known technique, detailed description thereof will be omitted.

The generating unit 12 has a function of generating a determination image from the determination information.

Here, the determination image means an image used for determining whether or not the content has been altered. The configuration for generating the determination image is not particularly limited, but it is preferable that the determination image be an image that is not easily visually recognized by a person when the determination image is output. As an example of a configuration for generating a determination image, there is a configuration in which a binary image of 1×128 pixels is generated from a hash value (128 bits) as determination information.

The displaying unit 13 has a function of displaying the determination image together with the content.

Here, the configuration for displaying the determination image together with the content is not particularly limited, but it is preferable that the determination image is also displayed so as to be within the field of view when a person visually recognizes the content. In an example of such a configuration, a determination image is displayed in the vicinity of a position where content is displayed. The image may be adjusted so that the display of the determination image does not collapse. That is, for example, a binary image of 1×128 pixels may be displayed in 2×256 pixels.

Each of the plurality of user terminals 20 and 201 to 20N is managed by a user, and is configured by, for example, a mobile phone terminal or PDA (Personal Digital Assistants). The configuration of the user terminal that can be included in the system 100 is not limited to the example described above, and may be any configuration that allows the user to recognize voice. Other examples of the configuration of the user terminal include a combination of various communication terminals and a personal computer.

Each of the plurality of user terminals 20 and 201 to 20N includes hardware (for example, a display device that displays automatically generated content) and software for connecting to the communication network 30 and executing various processes by communicating with the server 10. Each of the plurality of user terminals 20 and 201 to 20N may be configured to directly communicate with each other without using the server 10.

Next, the operation of the system 100 (system 100) of the present example will be described.

FIG. 3 is a flowchart showing an example of information processing corresponding to at least one of the embodiments of the present invention. In the information processing in this example, processing related to generating voice from text is performed. Hereinafter, a case where the server 10A and the user terminal 20 (terminal 20) execute information processing will be described as an example.

The information processing is started, for example, when the server 10A displays the automatically generated content.

In the information processing, the server 10A first converts the content into determination information (step S11). In this example, the server 10A converts the automatically generated content into determination information by hashing.

After converting the content into the determination information, the server 10A generates a determination image (step S12). In the present example, the server 10A generates an image from the hash value.

After generating the determination image, the server 10A displays the determination image together with the content (step S13). In this example, the server 10A transmits output information for outputting a screen including the determination image and the content to the terminal 20.

Upon receiving the output information from the server 10A, the terminal 20 outputs an image using a predetermined output unit (step S14). In the present example, the terminal 20 outputs an image to its own display.

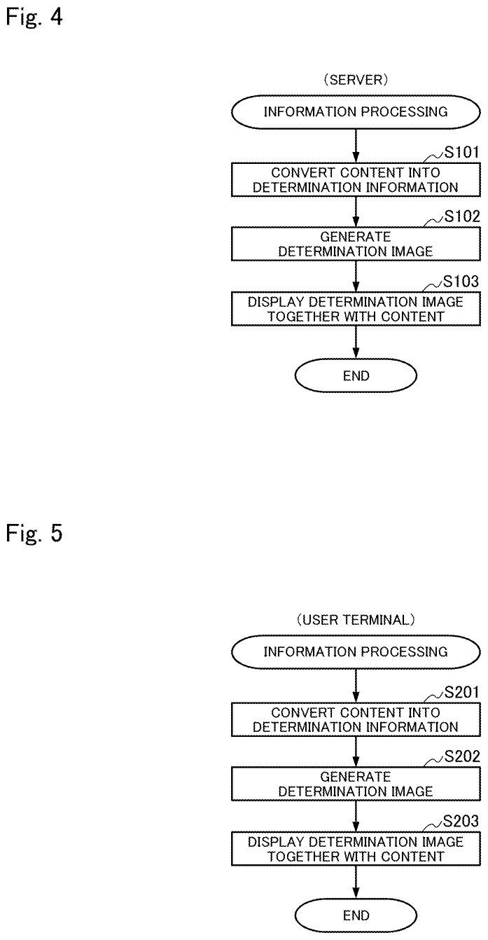

FIG. 4 is a flowchart showing an example of the operation on the server side in the information processing corresponding to at least one of the embodiments of the present invention. Here, the operation of the server 10A in the system 100 will be described again.

In the information processing, the server 10A first converts the content into determination information (step S101), generates a determination image from the converted determination information (step S102), displays the generated determination image together with the content (step S103), and ends the processing here.

FIG. 5 is a flowchart showing an example of the operation of the terminal side in the information processing corresponding to at least one of the embodiments of the present invention. Hereinafter, a case where the terminal 20 executes information processing by itself will be described as an example. Since the configuration of the terminal 20 has the same function as the configuration of the server 10A except for receiving various kinds of information from the server 10A, the description thereof is omitted from the viewpoint of avoiding redundant description.

In the information processing, the terminal 20 first converts the content into determination information (step S201), generates a determination image from the converted determination information (step S202), displays the generated determination image together with the content (step S203), and ends the processing here.

As described above, as one aspect of the first embodiment, since the server 10A that displays automatically generated content is configured to include the converting unit 11, the generating unit 12, and the displaying unit 13, at least a part of the automatically generated content is converted into information (determination information) used for determining whether or not the content has been altered, a determination image (so-called watermark) is generated from the determination information, and the determination image is displayed together with the content, it is possible to reduce the burden for responding to the modification of the content.

That is, since the determination image generated based on the automatically generated content is displayed together with the content, different information can be used as a watermark for each automatically generated content, and for example, as compared with a case where the same information (for example, identification information of a game title) is always used as a watermark, the content portion of the displayed image is replaced with another content (for example, it is possible to easily determine (modify) the automatically generated text to other contents.

The server 10A may be configured to receive an input of a screen (Information including content automatically generated or replaced by a specific system and determination image) as a parity check target, convert the content into determination information by a method corresponding to a specific system, generate a determination image from the converted determination information, determine that the content has not been modified when the generated determination image and the determination image included in the screen match, and determine that the content has been modified when the two determination images do not match.

### Second Embodiment

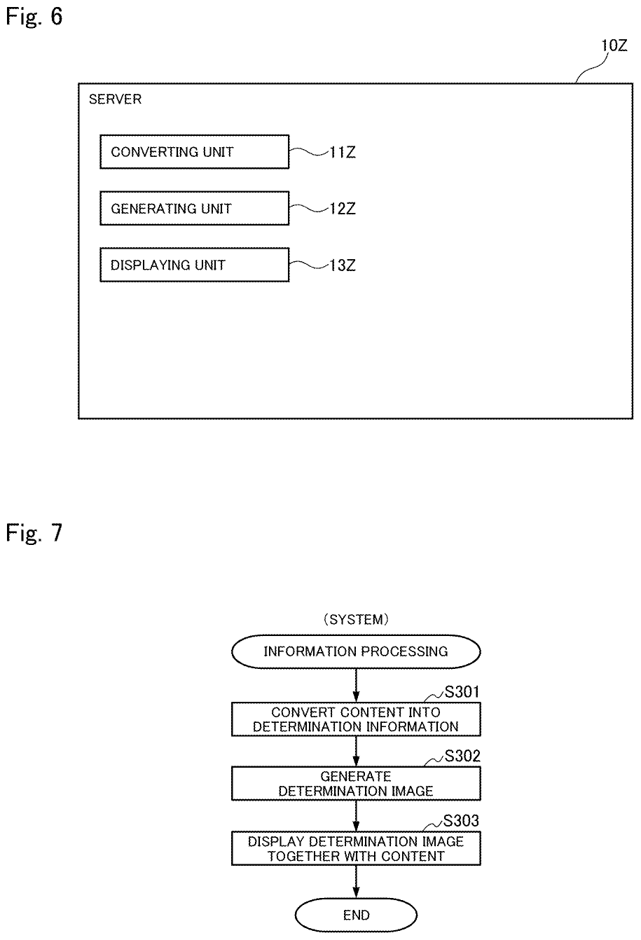

FIG. 6 is a block diagram showing a configuration of a server 10Z which is an example of the server 10 corresponding to at least one of the embodiments of the present invention. In the present example, the server 10Z includes at least a converting unit 11Z, a generating unit 12Z, and a displaying unit 13Z.

The converting unit 11Z has a function of converting at least a portion of the automatically generated content into information used to determine whether the content has been modified (hereinafter referred to as “determination information”).

Here, a configuration for automatically generating contents is not particularly limited, but a configuration in which various contents are generated by processing information input by a user by artificial intelligence (AI) is preferable.

The content is not particularly limited as long as it can be converted into a character string. Examples of the content include various kinds of information such as a character string (text), an image (still image, moving image), and sound.

The determination information means information used to determine whether the content has been modified. The configuration for converting the content into the determination information is not particularly limited, but it is preferable that the content cannot be generated from the determination information after conversion. In an example of such a configuration, the content is converted into a hash value by using a hash function.

The generating unit 12Z has a function of generating a determination image from the determination information.

Here, the determination image means an image used for determining whether or not the content has been altered. The configuration for generating the determination image is not particularly limited as long as the determination information is used. As an example of the configuration for generating the determination image, there is a configuration in which the determination image is generated using pixels corresponding to the number of bits of the determination information.

The displaying unit 13Z has a function of displaying the determination image together with the content.

Here, the configuration for displaying the determination image together with the content is not particularly limited, but it is preferable that the determination image and the content are simultaneously included in the display screen. In addition, since the determination image does not present the contents of the content to the user, it is preferable that the determination image is displayed in a form that is difficult to visually recognize by the user. However, it is preferable that the size and the size of the determination image be adjusted and displayed so that the determination image can be visually recognized even if the display screen is recorded and modified later.

FIG. 7 is a flowchart showing an example of information processing corresponding to at least one of the embodiments of the present invention. In the information processing in this example, processing related to adding determination information to automatically generated content is performed. Hereinafter, each process performed by the system 100Z including the server 10Z will be described. Note that the order of each process will be described with respect to each process having a contradiction in the content of the process. Note that the order of the respective processes is not the same as long as there is no contradiction in the contents of the processes.

The information processing is started, for example, when the system 100Z displays automatically generated content. Hereinafter, a case where the system 100Z controls the progress of the video game by automatically generating and displaying a sentence in response to a sentence input by the user will be described as an example.

In the information processing, the system 100Z first converts the content into determination information (step S301). In this example, the system 100Z converts the automatically generated sentence into determination information by hashing. That is, a hash value is generated using a hash function that generates a 128-bit value from a sentence of an arbitrary length.

After converting the content into the determination information, the system 100Z generates a determination image (step S302). In this example, the system 100Z generates a binary image of 1×128 pixels from the generated hash value.

When the determination image is generated, the system 100Z displays the determination image together with the content (step S303). In this example, the system 100Z displays a game screen including an automatically generated sentence and a binary image of 1×128 pixels. The determination image may be displayed in 2×256 pixels on the game screen so as not to be identifiable.

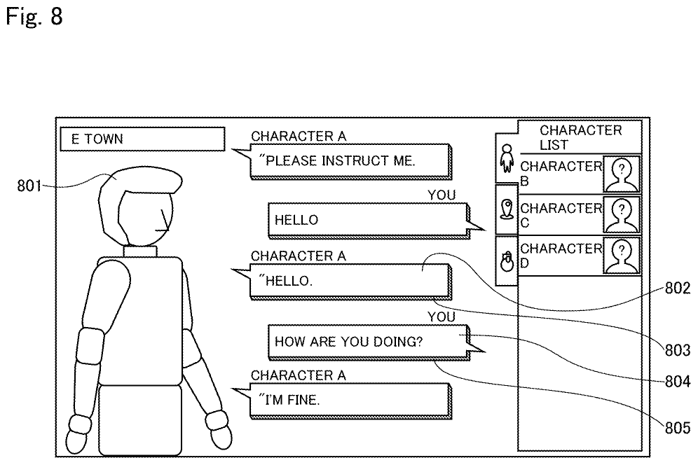

FIG. 8 is an explanatory diagram for explaining an example of a game screen; In the example of the game screen shown in FIG. 8, a character A, an area 802 representing the utterance by the character A, an area 803 in which a watermark corresponding to the utterance by the character A is embedded, an area 804 representing the utterance by the user, and an area 805 in which a determination image (watermark) corresponding to the utterance by the user is embedded are displayed.

Here, for example, it is known to display a watermark on a game screen displayed in accordance with the progress of the video game, but in the present example, a determination image generated from the utterance of the user that serves as a trigger for automatically generating the utterance of the character A and a determination image generated from the utterance of the character A that is automatically generated are displayed.

In addition, in this example, since the watermark generated in the same color as that of the shadow portion is displayed so as not to be conspicuous in the shadow portion (region 803, region 805) of the balloon in which each utterance (text) is displayed, play of the video game is not hindered.

As described above, as one aspect of the second embodiment, since the server 10Z that displays the automatically generated content (that is, displays the automatically generated content on the client) is configured to include the converting unit 11Z, the generating unit 12Z, and the displaying unit 13Z, at least a part of the automatically generated content is converted into information (determination information) used for determining whether or not the content has been modified, and a determination image is generated from the determination information, by displaying the determination image together with the content, it is possible to reduce the burden for responding to the modification of the content. That is, for example, by converting a sentence generated by a natural language generation technique into a hash value, generating a binary image from the hash value, and displaying a game screen including the binary image and the sentence, for example, even when a malicious user modifies and publishes a screen shot of the game screen, it is possible to reduce the burden of proving that the modification is malicious. That is, for example, when natural language generation is adopted in a video game, a scene in which information input by a user is returned as “Hello” is displayed as a game screen, and the game screen is copied and modified as “Hello”, and is published, a watermark corresponding to “Hello” is embedded in the published game screen, so that it can be determined that the game screen has been modified. This can be said to be a useful determination method from the viewpoint of not being able to say whether or not the content is modified due to the nature of the automatically generated content (i.e., because there is a possibility that the Al may make an inappropriate utterance). In addition, as compared with the case where the conventional watermark is mainly used to protect the copyright relating to the content, the present invention is useful in that it can contribute to protecting the content that realizes the automatic generation of the content from the problem caused by the content being modified and published.

In addition, by converting the content into a hash value using a hash function, it is not possible to decrypt the content automatically invited from the game screen including the determination image, but it is possible to determine whether or not the content has been modified by specifying a target for which it is desired to determine the presence or absence of modification from the game screen, hashing the target by the same method, and comparing the target with the game screen.

Further, since the determination image is generated by the pixels corresponding to the number of bits of the determination information, even when the determination image is generated every time the content is automatically generated, excessive processing load can be avoided.

In addition, when the display screen including the determination image and the content is displayed, it is possible to prevent the determination image from being unable to be identified by adjusting the size or the color of the determination image.

Further, by determining the positional relationship between the display position of the content and the determination image (For example, the automatically generated text is displayed in the balloon, and the determination image is displayed in the shadow of the balloon.), modification determination can be efficiently performed even when a plurality of automatically generated contents are displayed on one screen. Note that the position where the determination image is displayed may not change depending on the display position of the content. In this case, it is preferable to set a position at which the determination image can be displayed without being conspicuous, such as an edge of the screen, various windows, or a background. Further, the determination image may be embedded by editing a dot pattern of a predetermined display area (for example, a balloon or a conversation window). In this case, a determination image of a color corresponding to the color of the display region may be generated, and the generated determination image may be superimposed on a predetermined display region and displayed.

In addition, in a screen including a content region in which automatically generated content is arranged and a region different from the content region, a region (Hereinafter, this region is referred to as an “arrangement region”.) in which a determination image is arranged may be specified, and a screen in which the determination image is arranged may be displayed. In this case, a region in which the determination image is arranged may be specified within the content region, or may be specified outside the content region. In the case of specifying in the content area, for example, a fine determination image may be embedded in a text representing an automatically generated sentence (For example, in a case where a text of “Saji” is displayed in black characters, the determination image is embedded in the black characters.). In addition, in the case of specifying the position outside the content area, for example, a position where the luminance is low in the game screen may be specified as the arrangement position. By using the brightness of the screen that changes according to the progress of the game, for example, by arranging the determination image in the darkest portion, it is possible to prevent the world appearance of the game from being hindered.

Further, a configuration may be adopted in which a user's input to a system for automatically generating content is accepted, at least a part of the input is converted into information (Hereinafter, this information will be referred to as “second determination information”.) used to determine whether or not the input has been altered, a determination image (Hereinafter, this image will be referred to as a “second determination image”.) corresponding to the second determination information is generated, and the input, the second determination image, and the content are displayed together. That is, for example, by receiving input of a sentence from a user of a video game, hashing the received sentence, generating a binary image corresponding to the hash value, and displaying the input sentence, the generated binary image, and the automatically generated sentence together, modification of the input sentence can be determined. In this case, a sentence to be determined may be input to the system, and the binary image displayed by the input may be compared with the binary image on the screen including the determination target.

In addition, when the Al adopted by the system changes the content to be automatically generated under the same condition due to upgrading or machine learning, the information related to the automatic generation of the content may be selected, and the determination image may be generated from the selected information and the determination information. That is, for example, the system 100 may select the version of the Al and the content generation date and time from a predetermined information group as information related to automatic generation of the content, reversibly encrypt the information indicating the version of the Al and the content generation date and time, and generate the determination image together with the hash value of the content. With such a configuration, it is possible to check whether or not the same content is generated under the same condition when the alteration determination is performed. The information about automatic generation of content and the determination information may be hashed together to have a fixed length.

As described above, one or more deficiencies are solved by each embodiment of the present application. Note that the effects according to the respective embodiments are one example of a non-limiting effect or effect.

In the above-described embodiments, the plurality of user terminals 20 and 201 to 20N and the server 10 execute the above-described various processes in accordance with various control programs (e.g., a voice generation program) stored in a storage device included therein.

In addition, the configuration of the system 100 is not limited to the configuration described as an example of each of the above-described embodiments, and for example, a configuration in which a part or the whole of the process described as the process executed by the user terminal 20 is executed by the server 10 may be employed, or a configuration in which a part or the whole of the process described as the process executed by the server 10 is executed by any of the plurality of user terminals 20 and 201 to 20N (for example, the user terminal 20) may be employed. In addition, a part or all of the storage unit included in the server 10 may be included in any of the plurality of user terminals 20 and 201 to 20N. That is, a part or all of the functions of one of the user terminal 20 and the server 10 in the system 100 may be included in the other one.

Further, the program may be configured to cause a single device that does not include a communication network to realize part or all of the functions described as examples of the above-described embodiments.

### INDUSTRIAL APPLICABILITY

According to one of the embodiments of the present invention, it is useful to reduce a burden for responding to modification of content.

### Appendix

The above description of the embodiments describes at least the following invention so that those skilled in the art can practice the invention.

[1] A non-transitory computer readable medium comprising a program that, when executed, causes a server to perform:
displaying automatically generated content;
converting at least a portion of the automatically generated content into information (hereinafter, this is referred to as “determination information”.) used to determine whether the content has been modified;
generating a determination image from the determination information; and
displaying the determination image together with the content.

[2] The non-transitory computer readable medium according to [1], wherein when the program, when executed, causes the server to further perform:
converting the content into a hash value using a hash function.

[3] The non-transitory computer readable medium according to [1] or [2], wherein the program, when executed, causes the server to further perform:
generating the determination image using pixels corresponding to the number of bits of the determination information;
displaying a screen including the determination image and the content.

[4] The non-transitory computer readable medium according to any one of [1] to [3], wherein the program, when executed, causes the server to further perform:
specifying a region (hereinafter, this region is referred to as an “arrangement region”.) where the determination image is placed on a screen including a content region where the content is placed and a region different from the content region;
displaying a screen arranged the determination image.

[5] The non-transitory computer readable medium according to any one of [1] to [4], wherein the program, when executed, causes the server to further perform:
accepting user input to a system for automatically generating the content;
converting at least a portion of the input into information (hereinafter, this information will be referred to as “second determination information”.) that is used to determine if the input has been altered;
generating a determination image (hereinafter, this image will be referred to as a “second determination image”.) corresponding to the second determination information;
displaying the input, the second determination image, and the content are together.

[6] The non-transitory computer readable medium according to any one of [1] to [5], wherein the program. when executed, causes the server to further perform:
selecting information related to automatic generation of the content;
generating the determination image from the selected information and the determination information.

[7] The program according to any one of [1] to [4], wherein at least one of the functions realized by the server is realized by a user terminal capable of communicating with the server.

[8] A system comprising
a communication network;
a server;
a user terminal; and
one or more processors configured to:
   display automatically generated content;
   convert at least a portion of the automatically generated content into information (hereinafter, this is referred to as “determination information”.) used to determine whether the content has been modified;
   generate a determination image from the determination information; and
   display the determination image together with the content.

[9] The system according to [8], the one or more processors in the server configured to:
display automatically generated content;
converting at least a portion of the automatically generated content into information (hereinafter, this is referred to as “determination information”.) used to determine whether the content has been modified;
generating a determination image from the determination information; and
the one or more processors of the user terminal display the determination image together with the content.

[10] A non-transitory computer readable medium comprising a program that, when executed, causes a user terminal to perform:
displaying automatically generated content;
converting at least a portion of the automatically generated content into information (hereinafter, this is referred to as “determination information”.) used to determine whether the content has been modified;
generating a determination image from the determination information; and
displaying the determination image together with the content.

[11] A method for displaying automatically generated content, the method comprising,
conversion processing for converting at least a part of the automatically generated content into information (hereinafter, this is referred to as “determination information”.) used for determining whether the content has been modified,
generating a determination image from the determination information; and,
display processing for displaying the determination image together with the content.

[12] A method in which a system including a communication network, a server, and a user terminal displays automatically generated content,
conversion processing for converting at least a part of the automatically generated content into information (hereinafter, this is referred to as “determination information”.) used for determining whether the content has been modified,
generating a determination image from the determination information; and,
display processing for displaying the determination image together with the content.

What is claimed is:

1. A non-transitory computer readable medium comprising a program that, when executed, causes a server to perform:
displaying automatically generated content;
converting at least a portion of the automatically generated content into determination information for determining whether the content has been modified;
generating a determination image from the determination information; and
displaying the determination image together with the content.

2. The non-transitory computer readable medium according to claim 1, wherein the program, when executed, causes the server to further perform:
converting the content into a hash value using a hash function.

3. The non-transitory computer readable medium according to claim 1, wherein the determination image comprises a number of pixels corresponding to a number of bits of the determination information.

4. The non-transitory computer readable medium according to claim 1, wherein the program, when executed, causes the server to further perform:
specifying an arrangement region in which the determination image is configured to be arranged in a screen in either a content region in which the content is configured to be arranged or a region different from the content region; and
displaying the determination image in the arrangement region.

5. The non-transitory computer readable medium according to claim 1, wherein the program, when executed, causes the server to further perform:
accepting user input to a system for automatically generating the content;
converting at least a portion of the input into second determination information for determining if the input has been altered;
generating a second determination image corresponding to the second determination information; and
displaying the input, the second determination image, and the content together.

6. The non-transitory computer readable medium according to claim 1, wherein the program, when executed, causes the server to further perform:
selecting information related to automatic generation of the content;
generating the determination image from the selected information and the determination information.

7. A system comprising
a communication network;
a server configured to communicate through the communication network;
a user terminal configured to communicate through the communication network; and
one or more processors configured to:
display automatically generated content;
convert at least a portion of the automatically generated content into determination information for determining whether the content has been modified;
generate a determination image from the determination information; and
display the determination image together with the content.

8. A non-transitory computer readable medium comprising a program that, when executed, causes a user terminal to perform:
displaying automatically generated content;
converting at least a portion of the automatically generated content into determination information for determining whether the content has been modified;
generating a determination image from the determination information; and
displaying the determination image together with the content.
